(19) United States
(12) Patent Application Publication
(10) Pub. No.: US 2012/0145307 A1
(43) Pub. Date: Jun. 14, 2012

(54) METHOD OF MT FERRULE TERMINATION AND PROTRUSION EQUALIZATION FIXTURE

(75) Inventors: Mark Margolin, Highland Park, IL (US); Gregory Bunin, Lake Zurich, IL (US); Ilya Makhlin, Wheeling, IL (US)

(73) Assignee: OPTOGIG, INC., Northbrook, IL (US)

(21) Appl. No.: 13/390,740

(22) PCT Filed: Aug. 20, 2010
(86) PCT No.: PCT/US10/46136

§ 371 Date: Feb. 16, 2012

Related U.S. Application Data
(60) Provisional application No. 61/235,940, filed on Aug. 21, 2009.
(60) Provisional application No. 61/328,021, filed on Apr. 26, 2010.

(51) Int. Cl. B29C 65/48; B29C 65/78

(52) U.S. Cl. 156/72; 156/423

(57) ABSTRACT

A method for terminating a multifiber connector. A multifiber ribbon is stripped to the appropriate preliminary length A protruding from the ferrule. A cleave is performed for all fibers protruding from the ferrule leaving a residual fiber length A₁. Cleaving and fiber end-face forming can be achieved by either laser processing, electrical arch impact, plasma forming, or any other method of similar nature. To achieve the working protrusion of the fibers beyond the ferrule A₂, the ferrule is moved forward in a fixture until it stops against stopper B. The fibers are then pushed against the recess in the stopper for alignment until protrusion length A₂ is achieved. During the finishing process, the epoxy moves into the fiber holes between the fibers and the walls of the fiber holes by capillary action, without the need to move the ribbon or fibers, or remove epoxy from the contact surface of the ferrule.

This invention claims benefit to U.S. Provisional Patent Application Ser. No. 61/328,021 filed Apr. 26, 2010 and Application Ser. No. 61/235,940 filed Aug. 21, 2009, the entirety of which are hereby incorporated by reference.

### FIELD OF THE INVENTION

The present invention relates generally to multi-fiber fiber optic connection systems and in particular to a polishless method and fixture for terminating a multifiber connector. Applicant claims priority to Application

### BACKGROUND OF THE INVENTION

Connectors which mate MT style ferrules are known in the prior art. It is also well known to polish ferrule assemblies used in fiber optic connectors. The polishing of the fibers and ferrules after termination increases the transmission of the light signal through the fiber optic connector containing mated ferrule assemblies. Alignment is also critical so that optical communication is realized between the fibers of the two mating ferrules. Normally, polishing is a time consuming multi-step process. It is also labor intensive and operator dependent. It likewise involves expensive consumables. The process can vary and it is difficult to achieve consistently high performance.

With the present invention, traditional polishing is not needed. The fiber equalization tool can accurately control the fiber protrusion. The process can be used for MT (UPC and APC) and MT-RJ type ferrules and can also be adapted to single fiber ferrules.

### SUMMARY OF THE INVENTION

A method for polishless terminating of a multifiber connector is provided by the present invention. A multifiber ribbon is stripped to the appropriate preliminary length A protruding from the ferrule as shown in FIG. 2. A cleave is performed for all fibers protruding from the ferrule leaving a residual fiber length A₁ as shown in FIG. 3. Cleaving and fiber end-face forming can be achieved by either laser processing, electrical arch impact, plasma forming, or any other method of similar nature.

To achieve the working protrusion of the fibers beyond the ferrule A₂, the ferrule is moved forward in a fixture until it stops against stopper B as shown in FIG. 4. The fibers are then pushed against the stopper for alignment until desired protrusion length A₂ is achieved.

A polishless method of terminating an MT type ferrule is provided comprising pushing a fiber ribbon (inserted into a ferrule) forward from behind, until the ferrule contacts a stopper having a recess of a predetermined desired length. The fibers protruding from the ferrule are pushed forward independently from the ferrule until they contact the recessed area of the stopper. The recess in the stopper results in a fiber protrusion of the desired length and a controlled equalization of the protrusion of the fiber beyond the contact area of the ferrule.

The polishless termination process includes: cleaving of the fibers; fiber ends forming; pushing the ferrule and fibers forward; applying epoxy; and curing. Applying epoxy through the window of the ferrule is performed after the fibers are inserted into the ferrule and, wherein due to capillary action, epoxy travels along the capillaries within the fiber holes. A modified standard ferrule has a recess on the end face thereof which stops capillary action of uncured epoxy in order to prevent contamination of the ferrule end face and the fibers with an excessive amount of epoxy. The fiber end preparation can result in a bulge on the end of the fiber and the recess accommodates said bulge on the ends of the fibers.

A special protrusion equalization fixture is used to achieve the required protrusion. That fixture includes: an immovable protrusion equalizer: a movable ferrule holder; and a movable ribbon holder, all mounted on a shared base.

It is to be understood that both the foregoing general description and the following detailed description are exemplary and are not restrictive of the invention as claimed.

Numerous variations and modifications of the present invention are possible in view of the teachings set forth herein. The invention may be practiced otherwise than as specifically described herein.

The accompanying drawings, which are incorporated in and constitute part of the description of the invention, do not limit its scope. The scope of the invention should be determined based on the claims recited herein, including the full scope of equivalents thereof.

### BRIEF DESCRIPTION OF THE DRAWINGS

FIG. 1 is an exploded perspective view showing a modified MT ferrule.

FIGS. 2, 3, and 4 are cross-sectional views of three stages of the process of the present invention—all of which are taken along axis X-X of FIG. 1 and looking in the direction of the arrows.

FIGS. 5A, 5B and 5C provide a schematic view of the three stages of the termination process of the present invention.

FIGS. 6A-6D are perspective end views of the ferrule showing examples of various types of recesses that can be used at the contact end of the ferrule.

FIG. 7 is a partial cross-sectional view of FIG. 6B taken along line Z-Z and looking in the direction of the arrows.

FIG. 8A is a top plan view of fibers following thermoforming.

FIG. 8B is an elevated end view illustrating fibers in a terminated ferule.

FIG. 8C is an elevated end view of a fiber.

FIG. 9 shows the fixture for the polishless method for termination of a fiber optic ferrule of the present invention in an embodiment suitable for MT type ferrules.

FIG. 10 is a cross-sectional schematic view of the fixture taken along line CC-CC of FIG. 9 and looking in the direction of the arrows.

FIGS. 11A-11C are top views of the three stages of the process of the present invention.

### DETAILED DESCRIPTION OF THE INVENTION

While this invention is susceptible of embodiment in many different forms, there is shown in the drawing and will herein be described in detail several specific embodiments, with the understanding that the present disclosure is to be considered merely an exemplification of the principles of the invention and the application is not limited to the specific embodiments.

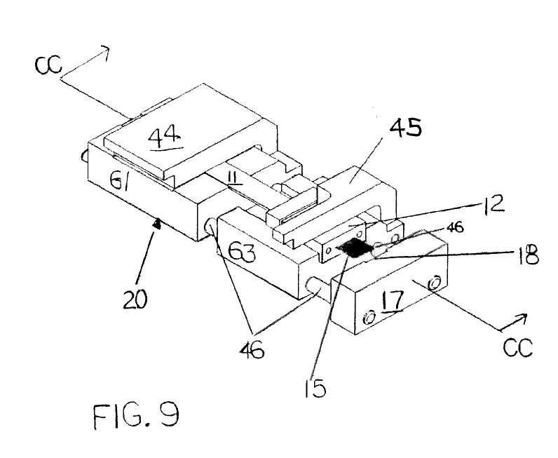

Referring now to the drawings wherein like reference numbers designate identical or corresponding parts throughout the several views. One embodiment of the fixture is shown in FIGS. 9, 10 and 11A-11C.

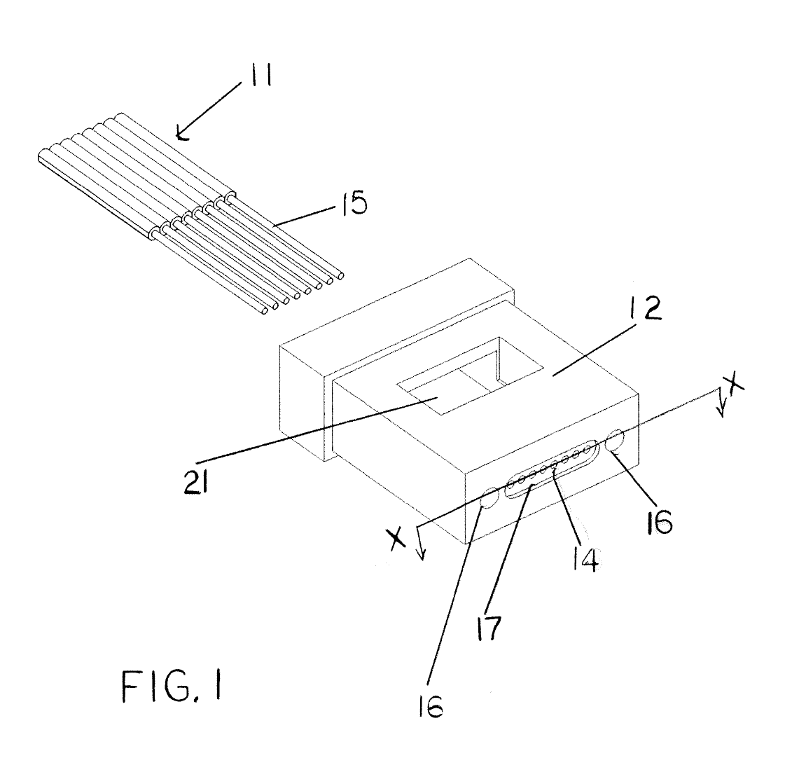

FIG. 1 is an exploded view showing modified MT ferrule 12 with window 21, multi-fiber ribbon 11 and exposed fibers 15. Multi-fiber ribbon 11 is to be inserted into the Mechanical Transfer (“MT”) type ferrule 12 with each fiber 15 inserted into one of the fiber holes 14. While multi-fiber ribbons are shown and described in the examples of this application, the use of loose fibers should likewise be deemed as being within the scope of this invention.

Typically, MT ferrules have alignment pin receiving holes 16 which accept alignment pins 51, as shown in FIG. 4, when two MT ferrules mate (not shown) so as to align the two mating ferrules. Alignment is critical so that optical communication is realized between the optical fibers of the mating ferrules; the ferrules must contain contact with each other. While the current example illustrates several versions of a modified MT ferrule, other multi-fiber type ferrules should be deemed as being within the scope of the invention.

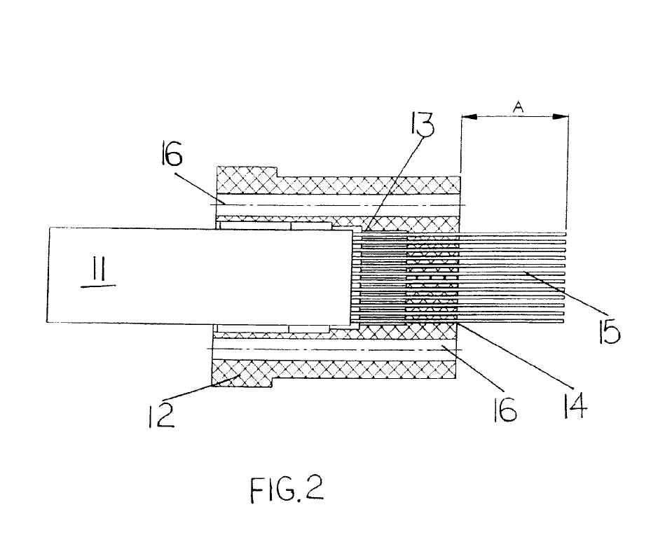

Turning to FIGS. 2, 3, and 4, they are cross-sectional views of three stages of the process of the present invention, all of which are taken along axis X-X of FIG. 1 and looking in the direction of the arrows. In FIG. 2, during the first stage of the termination process of the present invention, the protruding fibers 15 are shown within fiber holes 14 of ferrule 12 including v-grooves 13 and have a preliminary length A. Also shown in FIG. 2 are pin holes 16 and ribbon 11.

Turning to FIG. 2, the MT ferrule 12 is shown with protruding fibers 15 having a preliminary length A. Following cleaving, which can be done either mechanically or by laser (or other methods mentioned herewithin), the protruding fiber 15 has a length of A₁ as shown in FIG. 3. Also shown in the cross-sectional view (along axis X-X of FIG. 1 and in the direction of the arrows) of the ferrule 12 shown in FIG. 3, are the fiber ribbon 11, the v-grooves 13, pin holes 16 and the fibers 15 passing through and protruding from the fiber holes 14.

FIG. 3 shows the ferrule 12 having protruding fibers with length A₁ prior to being pushed into contact with stopper (B) 17 having recess 18, as shown in FIG. 4, and prior to gluing of the fibers 15 with epoxy (not shown) applied at window 21 within the ferrule 12. The fibers 15 are moveable within the ferrule 12, by bringing the ferrule 12 into contact with stopper (B) 17 at ferrule stopper contact point 19, as shown in FIG. 4. The fibers 15 contact the stopper (B) 17 within recess 18 and are pushed backwards within the ferrule 12 until the ferrule 12 contacts the stopper contact point 19, as shown in FIG. 4. Because of the size (i.e., depth) of the recess 18 of stopper (B) 17 the desired fiber protruding length A₂ is achieved.

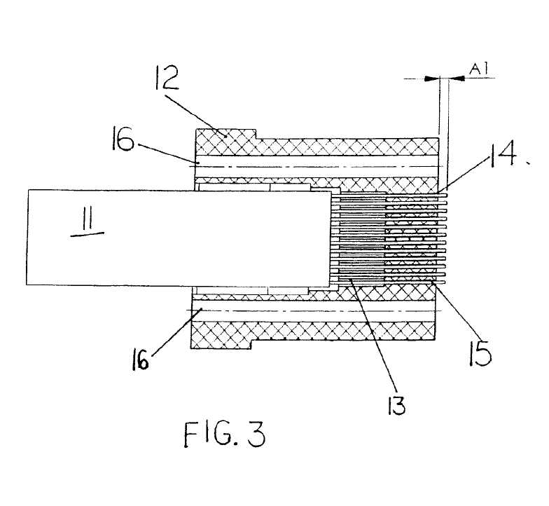

FIGS. 5A, 5B and 5C provide a schematic view of the three stages of the termination process of the present invention. In FIG. 5A, the protruding fibers 15 of ferrule 12 have a preliminary length of A. In FIG. 5B, following cleaving, the protruding fibers have a length of A₁, prior to gluing of the fibers 15 within fiber holes 14 by applying epoxy through window 21. Finally, in FIG. 5C, the desired protrusion length of A₂ of fibers 15 is achieved because of the size of the recess 18 when stopper (B) 17 is contacted by ferrule 12 at contact point 19.

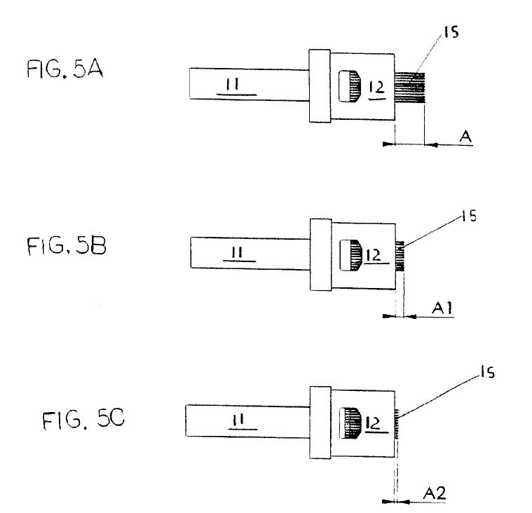

In conventional termination methods, the ribbon 11 is moved back and forth several times to make sure epoxy moves into the fiber holes 14. However, this results in epoxy being deposited on the contact surface, which then requires laborious and often expensive polishing thereof. As shown in FIG. 7, in the finishing process of the present invention, the epoxy moves into the fiber holes 14 between the fibers 15 and the walls of the fiber holes 14 by capillary action, without the need to move the ribbon and without the need to remove epoxy from the contact surface of the ferrule 12. The capillary action is facilitated by the fact that, in the present invention, epoxy goes into the capillary formed around the fiber 15 within fiber holes 14 being heated up (and thus becomes less viscous) during the curing process.

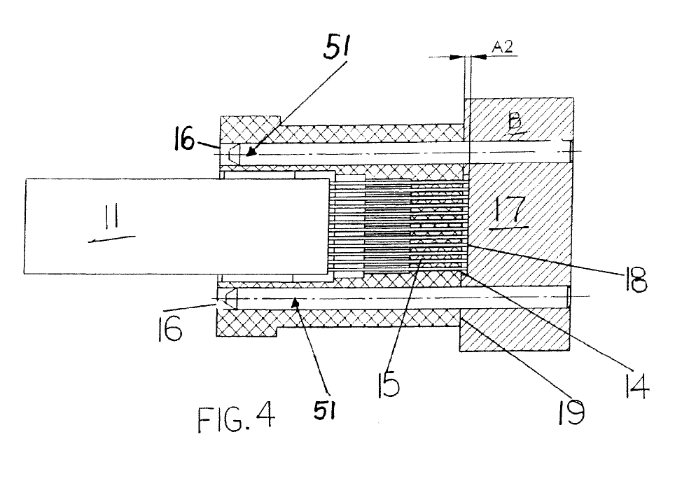

In the present invention, the epoxy does not go beyond the contact surface. As shown in the cross-sectional view of FIG. 7 of ferrule 12 (which is a partial cross-sectional view of FIG. 6B taken along line Z-Z and looking in the direction of the arrows), recess 17B having depth BB, surrounds all of the fiber holes 14 and fibers 15 extend beyond the edge. As a result, as shown in FIG. 7, epoxy 71 drawn through fiber hole 14 around fiber 15 by capillary action inside of the capillary formed within fiber hole 14 ends at epoxy meniscus 72 below the contact surface 50 of ferrule 12, so as to avoid the need to polish the contact surface.

Epoxy 71 can be applied to fibers 15 through window 21 (not shown in FIG. 7) of ferrule 12. Fibers 15 extends through each fiber hole 14 and beyond the contact surface of ferrule 12 by distance AA as shown in FIG. 7. Capillary action draws epoxy 71 through the capillary formed around fiber 15 within fiber hole 14 and ends below the contact surface 50 within recess 17B at the level of epoxy meniscus 72.

As shown in FIGS. 6A through 6D, various types of recesses 17A-17D can be used at the contact end of the ferrule 12. End view FIG. 6A shows individual circular recesses 17A around each fiber hole 14 in the form of chamfers. End view FIG. 6B shows contact end of ferrule 12 with a closed version of recess 17B comprising a trough region surrounding fiber holes 14 as a unit, but not extending as far as pin holes 16.

FIG. 7 is a partial cross-sectional view of FIG. 6B taken along line ZZ and in the direction of the arrows, showing trough shaped recess 17B above fiber holes 14, between pin holes 16. Also shown in FIG. 7, fiber 15 within fiber hole 14 and extends beyond recess 17B of ferrule 12. Epoxy is drawn along the capillary formed around fiber 15 within fiber hole 14 by capillary action and finishing within recess 17B in the form of epoxy meniscus 72.

Alternatively, as shown in end view FIG. 6C, ferrule 12 includes a semi-closed version of recess 17C forming a trough that spans from the edges of one pin hole 16 to the other, but does not extend beyond the edges of pin holes 16 and surrounds fiber holes 14.

End view 6D shows a recess shape 17D that surrounds fiber holes 14 and extends into pin holes 16 and goes beyond those holes to the side surfaces of the ferrule.

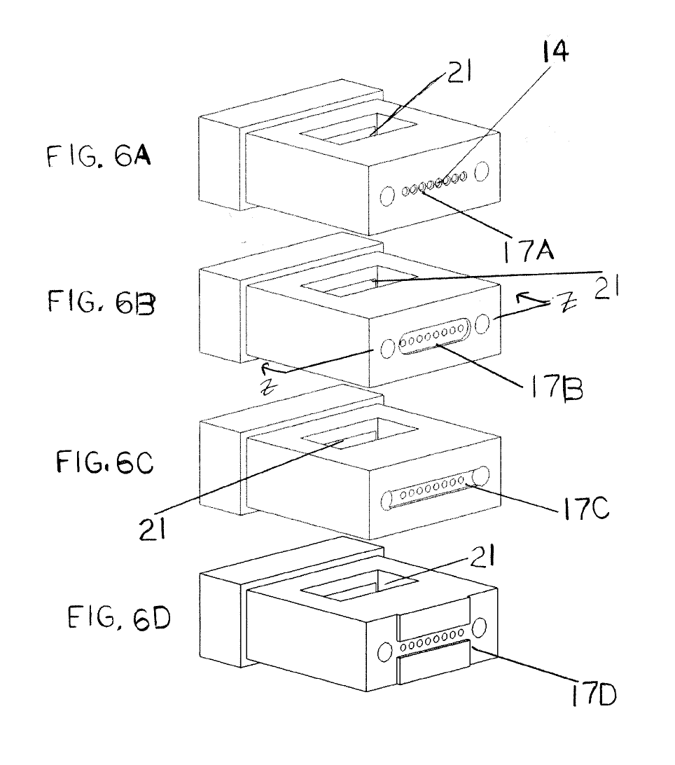

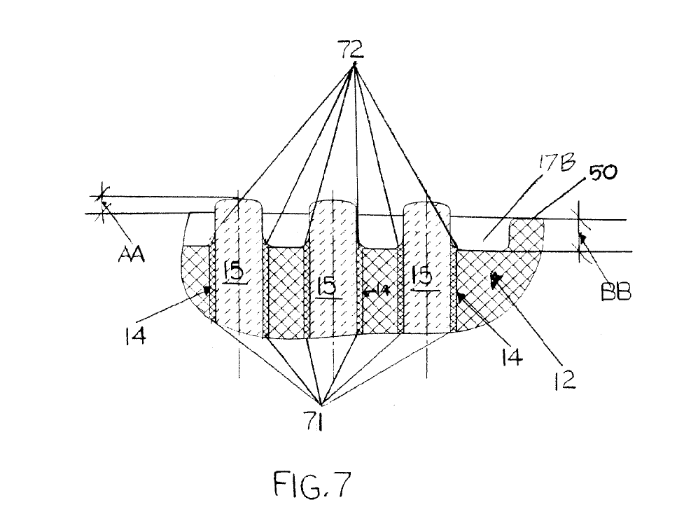

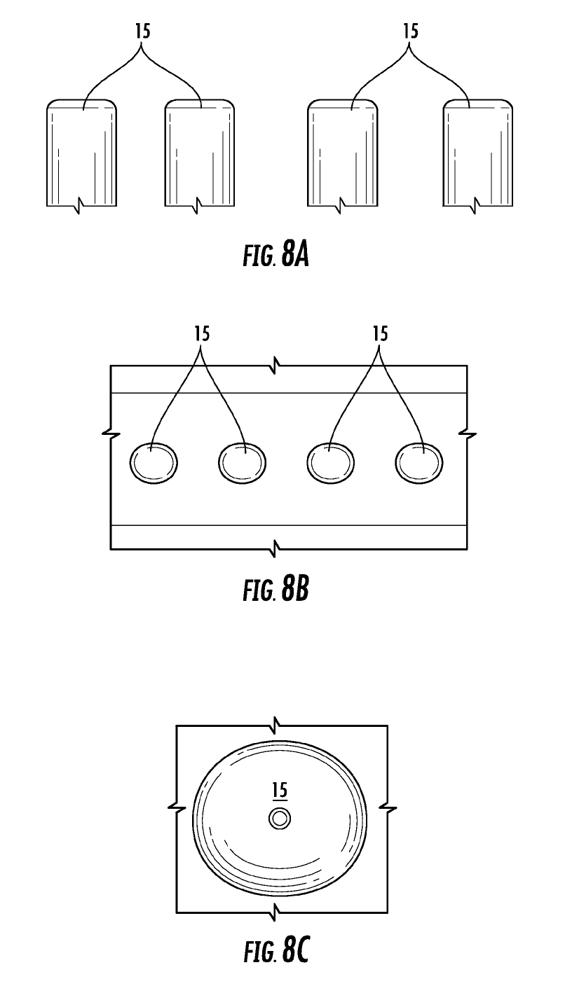

FIG. 8A shows the fibers 15 following thermoforming. Flu. NB shows the fibers in a terminated ferrule showing protrusion of the fiber 15 beyond the ferrule contact service. FIG. 8C is a close-up image of the fiber.

With respect to FIGS. 8A-8C, the mechanical cleaving or laser cleaving is used before the thermoforming process is applied. The thermoforming methods may be laser forming, electrical arc forming, or plasma forming. This, in combination with the protrusion equalization method, results in very controlled precision.

In the conventional processes, the fibers are cleaved, cured and polished. In the invention of the present application, the fibers are cleaved, thermoformed, pushed to the equalizer until they stop, epoxy applied, and cured.

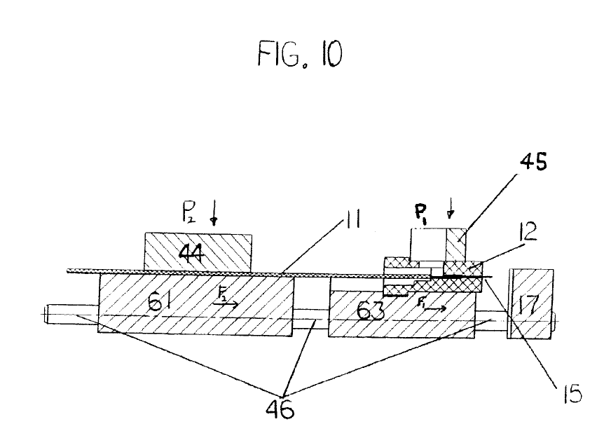

A fixture for the polishless method for termination of a fiber optic ferrule of the present invention is shown in FIGS. 9, 10, AND 11A-C in an embodiment suitable for MT type ferrules, though the invention should not be deemed limited to only MT type ferrules 12. FIG. 10 is a cross-sectional schematic view of FIG. 9 taken along axis CC and in the direction of the arrows.

This fixture 20 was designed for the termination method of the present invention where ends of fibers 15 are prepared for physical contact without using a polishing process. Instead of polishing, several other methods can be used, such as but not limited to: laser cleaving with rounding ends; electrical arc discharge method with melting of the ends; and plasma forming of the fiber ends, etc.

1. The fixture 20 as shown in FIGS. 9, 10, and 11A-C consists of the following parts:
a. Stopper/protrusion equalizer 17;
b. MT ferrule block 63
c. MT ferrule holder 45;
d. Ribbon block 61; and,
e. Ribbon holder 44.

2. Parts description
a. Base 46 in the form of two rods holds all the parts;
b. Stopper block 17 is immovably positioned on the rods;
c. Stopper/Protrusion equalizer (also referred to as “block”) 17 has a recess 18 of about 3 to 10 microns deep (or with any other desired depth) to achieve desirable fiber protrusion and protrusion equality with submicron accuracy;
d. MT ferrule block 63 together with holder 45 holds MT ferrule 12 in a moveable fashion so that ferrule can be moved toward stopper/equalizer 17 until it stops and stays in that position under the constant force F₁. At the same time, ferrule 12 is constantly pushed down to the block 63 by the holder 45 with the downward force P₁.
e. Ribbon block 61 together with the holder 44 holds fiber ribbon 11 in a moveable fashion so that ribbon 11 can be pushed forward by the force F₂ until stripped and formed fibers 15 are stopped against the bottom of the recess 18 of the stopper/equalizer 17. Since this part of the process takes place in the curing oven, the acrylic buffer is already soft to some degree. That fact allows fibers 15 to individually move slightly relative to each other inside of the buffer. It keeps all fibers 15 in the ferrule 12 protruded equally, while protrusion itself is determined by the depth of the recess 18 in the stopper/equalizer 17.
f. Ribbon holder or magnetic clamp 44 keeps ribbon 11 immoveable against the ribbon holder 44 and the ribbon block 61 under the downward force P₂.

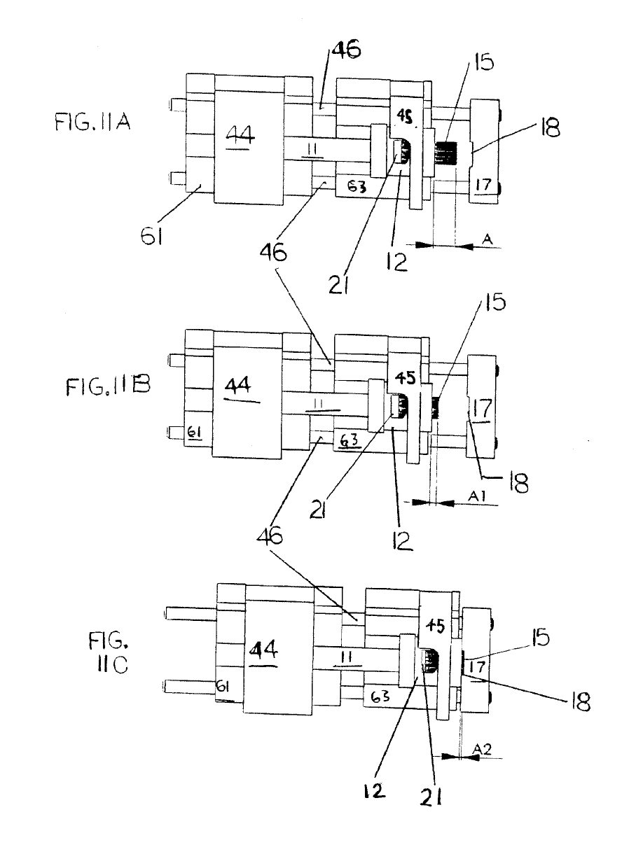

3. Function description:
a. Step 1—Fiber ribbon 11 is stripped and cleaved to the appropriate length;
b. Step 2—Fiber ribbon 11 is inserted into special MT ferrule 12 so that fibers 15 protrude relatively far as shown in FIG. 11A;
c. Step 3—Ends of fibers 15 are shaped by one of the methods described herein; this step can be performed outside or inside of this fixture 20;
d. Step 4—ferrule 12 with fibers 15 is mounted on MT ferrule holder 63 and fixed on it by the holder 45 with the force P₁ as shown in FIGS. 10 and 11B;
e. Step 5—Ferrule holder 63 is pushed against stopper block 17 with the force F₁; during this process, ferrule 12 pushed forward until it stops against stopper/equalizer 17 shown in FIGS. 10 and 11C;
f. Step 6—Tail of the ribbon 11 is mounted on the Ribbon block 61 and is held in place by the holder 44 under the force P₂ while being pushed toward the ferrule 12 with force F₂ as shown in FIGS. 10 and 11C; during this process, fibers 15 are pushed forward until they stop against the recess 18 of the stopper/equalizer 17;
g. Step 7—Epoxy 71 is applied to the MT ferrule 12 through its window 21;
h. Step 8—The whole fixture 20 is installed in the curing oven; during the heating process, fibers 15 are further pushed against the stopper/equalizer 17, then epoxy 71 becomes more liquid and thus penetrates into the fiber holes 14 by capillary action, and finally epoxy 71 fully cures; due to the shape of the recesses such as 17B on the ferrule 12, capillary action stops right on the bottom of each recess such as 17B at meniscus 72 thus protecting fiber 15 end-faces from being contaminated with epoxy 71.

The scope of the invention is not to be limited to the particular order of steps described, claimed or shown herein, but includes such different orders of steps as may be used by those of ordinary skill in the art. Furthermore, as will be recognized by those skilled in the art, the concepts described in the present application can be modified and varied over a tremendous range of applications and accordingly, the scope of the claimed subject matter is not to be limited by any of the examples given.

1. A polishless method of terminating a ferrule having an end face and one or more fibers inserted within fiber holes in the ferrule and protruding therefrom, the method comprising:
pushing the ferrule forward until the ferrule contacts a stopper having a recess of a predetermined desired length;
pushing the one or more fibers protruding from the ferrule until the fibers contact the recessed area of the stopper;
wherein the recess in the stopper results in a fiber protrusion of the desired length and a controlled equalization of the protrusion.

2. The method of claim 1 wherein the process further comprises the steps of:
cleaving the fiber,
fiber ends forming,
pushing the ferrule and fibers forward,
applying epoxy,
and curing;
wherein applying epoxy is performed after the fibers are inserted into the ferrule and, wherein due to capillary action, epoxy travels along the fiber holes.

3. The method of claim 1 wherein:
the ferrule has a recess on the end face thereof which stops capillary action of uncured epoxy in order to prevent contamination of the ferrule end face and the fibers with an excessive amount of epoxy.

4. The method of claim 3 wherein:
the fiber end preparation results in a bulge on the end of the fiber; and,
the recess accommodates the bulge on the ends of the fibers.

5. The method of claim 1 including:
a special protrusion equalization fixture used to achieve the required protrusion;
the fixture including:
an immovable protrusion equalizer:
a movable ferrule holder; and,
a movable ribbon holder all mounted on a base.

6. A fixture for polishless termination of a ferrule having one or more fibers protruding therefrom comprising:
a base;
a stopper block immovably positioned on the base;
the stopper block having a recess to achieve the desired amount of fiber protrusion and protrusion equality with submicron accuracy; and,
a ferrule block for holding the ferrule in a moveable fashion along the base so that the ferrule can be moved along the base toward the stopper until the ferrule with the protruding fibers is stopped by contact with the stopper and stays in contact with the stopper.

7. The fixture of claim 6 wherein the base comprises one or more rods.

8. The fixture of claim 6 further including a ribbon holder movably mounted on the base for moving the fibers forward into contact with the recess of the stopper.
